(19) United States
(12) Patent Application Publication
(10) Pub. No.: US 2021/0004856 A1
(43) Pub. Date: Jan. 7, 2021

(54) INCENTIVE MANAGEMENT SYSTEM

(71) Applicant: KEMIA ISOFTWARE LIMITED, Chennai (IN)

(72) Inventor: Kulothungan KANDAPPAN KANDAPPAN, Chennai (IN)

(21) Appl. No.: 16/982,730

(22) PCT Filed: Mar. 19, 2019
(86) PCT No.: PCT/IN2019/050223

§ 371 Date: Sep. 21, 2020

(30) Foreign Application Priority Data
Mar. 19, 2018 (IN) 201841009959

(51) Int. Cl. G06Q 30/02

(52) U.S. Cl. CPC G06Q 30/0222; G06Q 30/0235

(57) ABSTRACT

The invention relates to a computer implemented incentive management system for innovative and efficient use of margins in financial transaction deals. More particularly, the present invention relates to the system for innovative and efficient use of margins in any financial transaction wherein the total value of the transaction is returned as a reward or incentive to the user registered on the incentive management platform. The incentive management system (100) comprises of a registered seller domain/database (20), a registered user domain/database (10), a purchase module (30), a transaction module (40), a database/memory (90) for data storage and an incentive management platform (200). Additionally the incentive management system is the purchase interface between user and the seller registered on the incentive management platform. The present invention is a self generating cashback model.

### TECHNICAL FIELD

The invention relates to a computer implemented incentive management system for innovative and efficient use of margins in financial transaction deals. More particularly, the present invention relates to the system for innovative and efficient use of margins in any financial transaction wherein the total value of the transaction is returned as a reward or incentive to the user registered on the incentive management platform. Additionally the incentive management system is the purchase interface between user and the seller registered on the incentive management platform. The present invention is a self generating cash back model.

### BACKGROUND ART

With the variety of ecommerce sites and cash back plans available on the internet or the web; there is tremendous scope for brand-marketing and wealth management in future. But fraud and consumer loyalty is a major concern for most of the brands in the ecommerce business.

The internet provides a promotion resource with its speed and distribution ability but customers face issues regarding wealth management, spend pattern and savings. With the average percentage running upto 25% of redemption, the cost of fraud is ever increasing.

Package goods manufacturers have greater concern regarding fraud on a retailer basis and the costs of production and customers only earn to spend rather than saving. Conventional approaches and existing inventions do not adequately address these concerns.

Rebates are effective but not nearly as widely accepted as coupons due to lag time and the lack immediate gratification of the shopper. Post shopping submission and the lack of immediate gratification make rebates less popular, though effective loyalty builders.

Most rewards discounts rebates are either immediate or over time but are static in nature. The incentive management system or platform devised in the present invention is a dynamic engine that will allow the user or the buyer's rewards/reward points to grow or enhance or mature.

The internet is ideally suited to assist in the exiting dilemma of conventional brand marketers utilizing cash back offers. Utilizing the World Wide Web brand target-marketing to the masses is possible and affordable, regardless of the product, the locale or the prospect. But redemption fraud is a major concern, as is the expense of conventional mass marketing and loyalty issues.

US20060195359A1 relates to a combined rewards system and process. A system and process that awards rewards currency, e.g. cash back rebate or rewards points, for credit card and check card purchases and that provides rewards for a customer's enterprise relationship is provided. Further provided is a methodology for enrollment into the combined rewards program or the relationship rewards program. Further provided is a methodology to show total combined points or cash earned where the points or amount of cash earned is parsed into the various accounts and purchases. Further provided is a methodology to communicate the currency earned by providing customers with periodic statements and newsletters, data online, and data through customer service representatives. Further provided is a mechanism by which to systematically enroll eligible products or services as defined by the enterprise, e.g. where the eligibility may be based on social security numbers or other unique customer numbers. However, this invention needs external source which provides cash back and minimum purchase criteria.

US20130080239A1 discloses a System and Method for Incentives. The invention relates generally to systems and methods for the non-public creation, distribution and redemption of incentive offers. More particularly, the system and method generates incentives based on parameters selectable by merchants. The system and method constructs non-public incentive offers that are delivered to one or more program registrants satisfying a designated targeting profile and associated with one or more electronic payment instruments. Incentive offers may be redeemed confidentiality by the program registrant tendering an electronic payment instrument satisfying the parameters of the incentive offer. The invention further relates to systems and methods for participants to exert control over the volume and kind of incentives received through the system and by third party entities. However the cash back method is static and does not vary with time.

US20080059303A1 discloses a transaction evaluation for providing rewards. An amount of loyalty program currency is pre-selected by a consumer and exchanged for a corresponding value-added reward also pre-selected by the consumer. The pre-selected reward, which can be a value added back to the consumer payment device, is given when the consumer conducts their pre-selected transaction using their consumer payment device. The amount of the loyalty program currency can be added back to the consumer payment device, and later exchanged for the consumer pre-selected value-adding rewards, by the consumer's transactional use of their consumer payment device. Consumer pre-selected value-added rewards, for instance, can appear as statement credits to an account associated with the consumer payment device. As such, an incentive exists for the consumer to pre-select a transaction to conduct with their consumer payment device to realize a corresponding pre-selected statement credit for such loyal use of their consumer payment device. However the rewards are sent back as value added rewards to the payment devices.

US20080319854A1 discloses a reward system and method for online credit and debit card transactions. A reward system and method including a card issuing institution that issues debit or credit cards to cardholders. Each cardholder has a cash back account set up by the institution and a cash back program provided by said institution rewards its cardholders with a predetermined cash value dependent on the cardholder's usage of the credit or debit card used by the cardholder and depositing said cash value in the cardholder's cash back account. The institution provides the identity of at least one supplier and each cardholder has online access to said supplier so that the cardholder can purchase goods or services from the supplier upon accumulation of a predetermined amount of cash in the cardholder's cash back program. The institution provides an online clearing program for receiving sales information from the supplier when a purchase is made by a cardholder and debiting said cardholder's cash in the cash back program with the amount of the sales information. Alternatively, an internet provider may be the clearing house for the system coupled to the cardholder, the card issuing institution, and the supplier. However credit or debit cards are used to initiate the cash back.

US20100250355A1 discloses a redemption of reward points as cash and deposit of cash to checking, savings or other accounts. Systems and methods of redeeming reward points for cash and depositing the cash to a checking or savings account of a user is presented. In some arrangements, the user will input account information relating to one or more checking or savings accounts. The information may be stored by the system. The user may select to redeem some or all of the reward points in his or her reward account balance as cash. Upon selection of this option, the user may select one or more of the saved accounts to which the funds will be deposited. In some arrangements, the redemption may occur automatically upon occurrence of a triggering event or meeting a predetermined threshold. However this invention is only a redemption method.

Background art has not provided an incentive management system that provides a full transaction value as incentive for redemption. No background art hitherto has been devised to provide an incentive as 100% cash back to the customer after the purchase, without tracking the customer movement. Accordingly, the present invention discloses a computer implemented incentive management system executed by computer operable instructions that provides a system for complete transaction value for redemption after a predetermined period of time.

### DISCLOSURE OF INVENTION

### Objects

It is the primary object of the present invention to provide a system for innovative and efficient use of margins in financial transaction deals.

It is another object of the present invention to provide an incentive management system that provides the customer with the opportunity to receive cash back equivalent to the transaction value of the transaction done through the incentive management system or platform.

It is another object of the present invention to provide a computer implemented incentive management system/platform to provide users an opportunity to convert spending into earnings.

It is another object of the present invention to provide a platform that gives 100% cash back to the customer.

It is another object of the present invention to provide a computer implemented incentive management system/platform, wherein incentives are electronically redeemed on the system and prevents duplicate and fraud redemptions.

It is further object of the present invention wherein the incentive management system provides a means to identify real or fraudulent users.

### SUMMARY

One or more of the problems of the conventional prior art may be overcome by various embodiments of the present invention.

It is the primary aspect of the present invention to provide an incentive management system (100) comprising:
a registered seller domain/database (20);
a registered user domain/database (10);
a purchase module (30);
a transaction module (40);
a database/memory (90) for data storage; and
an incentive management platform (200), comprising of an incentive generation module (50), an incentive storage module (70), and an incentive redemption module (60),
   wherein the seller database (20), the user (30) and the incentive management platform (200) are in communication by a wireless network,
   wherein the purchase module (30) is configured to complete the purchase when accessed by the user for merchandise sold by the seller at the registered seller domain (20);
   wherein the transaction module (40) is configured to perform the purchase transaction,
   wherein the incentive generation module (50) is configured to generate an incentive value from the transaction value for a predetermined period of time,
   wherein the value of the incentive is determined as equal, less or greater than the purchase transaction value made by the user,
   wherein the platform (200) is configured to perform the incentive management for any value of the purchase transaction,
   an incentive storage module (70) that stores and enhances the incentive value until the completion of the predetermined period,
   wherein the redemption module (60) redeems the value of the incentive to the user after the completion of the predetermined time period, notifies and distributes it to the user, and
   wherein the incentive management platform (200) is configured to return complete transaction value as an incentive to the user dynamically after the pre-determined period of time.

It is another aspect of the present invention, wherein the incentive management platform (200) is a purchase interface between the merchant or seller and the user.

It is another aspect of the present invention, wherein the incentive management system is configured to display the merchandise of the registered seller.

It is another aspect of the present invention, wherein the incentive management system is a network enabled system which can be accessed using any computer or a network implementable device. It is another aspect of the present invention, wherein the incentive includes one of cash back, statement credit and amount redeemable on selected goods and services.

It is another aspect of the present invention, wherein the incentive management platform (200) generates activity reports on incentive activity for the sellers.

It is another aspect of the present invention, wherein the incentive management platform (200) tracks the buying pattern of the user and stores in the database (90).

It is another aspect of the present invention, wherein the incentive generation module (50) uses the margins existing in the purchase transactions to be segregated and set aside for the incentive as cash-back to the customer.

It is another aspect of the present invention, wherein the registered user domain or database (10) displays the predetermined time after which the user is redeemed with the incentive value on communication by the incentive management platform (200).

It is another aspect of the present invention, wherein the incentives are distributed to the platform (200) by the seller and are be viewed and accessed by the network enabled system.

It is another aspect of the present invention, wherein the incentives are maintained by the incentive management platform (200) and the predetermined time period for redemption of incentive.

It is another aspect of the present invention, wherein the network operated device is a computer, desktop, laptop, or any hand held computer or a mobile phone with data connectivity.

It is another aspect of the present invention to provide a method of automated incentive management by an incentive management system (100), comprising of steps:
accession of a seller domain or database (20) for purchase of any article or entity, by a user and user authentication of the database;
completion of a purchase transaction of the article or entity by the user on the seller domain (20) accessed on registered user domain (30) and executed by transaction module (40);
network implemented communication of the transaction event to an incentive management platform (200) in communication with the seller domain (20) and the user domain (30) through a wireless network;
management of the incentive by the incentive management platform (200) for a predetermined period configured to reimburse the user with the predefined purchase transaction value;
   wherein the platform (100) is configured to invest the aggregated margins through the transaction and provide back to the customer as incentive,
   wherein the platform (100) is incentive management through an investment of the margin availed in the wealth management plan based on customer interest for a predetermined period of time,
   wherein the management of the incentive comprises of determination of part of the transaction value to be deducted from the transaction value by the incentive generation module (50) on the incentive management platform (200),
   storing the deducted margin value in the incentive storage module (70) for a predetermined period of time,
   execution of the incentive redemption process to the registered user domain by the incentive redemption module (60) on completion of the predetermined period, updating dashboard of the end user with the time period for complete redemption of the transaction value, and
   management of the incentive by the platform (200) during the predetermined period for maturity of the incentive value deducted by the platform to the total purchase incentive value,
   redemption of the incentive to the user on completion of the predetermined maturity period, and
   wherein the incentive redemption module (60) supports the dynamic growth of cash back based on time.

It is another aspect of the present invention, wherein the period of maturity is the time period configured by the incentive management platform (200) for the deducted margin value on the transaction to equalize to the total purchase transaction value.

### BRIEF DESCRIPTION OF DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawing, which form a part of this specification. It is to be noted, however, that the drawing illustrate only a preferred embodiment of the invention and is therefore not to be considered limiting of the invention's scope as it may admit to other equally effective embodiments.

FIG. 1: illustrates flowchart of the incentive management system according to one embodiment of the present invention.

### BEST MODE(S) FOR CARRYING OUT THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The invention relates to a computer implemented incentive management system for innovative and efficient use of margins in financial transaction deals. More particularly, the present invention relates to the system for innovative and efficient use of margins in any financial transaction wherein the total value of the transaction is returned as a reward or incentive to the user registered on the incentive management platform. Additionally the incentive management system is the purchase interface between user and the seller registered on the incentive management platform.

A system is provided for innovative and efficient use of margins in any financial transaction deals routed through a computer comprising an incentive management system as an instrument to provide the buyer multiple returns as enhanced returns for the product the customer purchases.

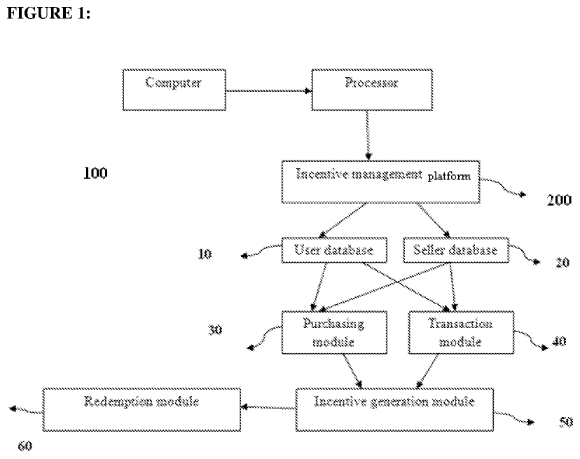

Referring to FIG. 1, the flowchart of the incentive management system according to one embodiment of the present invention is illustrated. An incentive management system (100) comprises of a registered seller domain/database (20), a registered user domain/database (10), a purchase module (30), a transaction module (40), a database/memory (90) for data storage and an incentive management platform (200) comprising of an incentive generation module (50), an incentive storage module (70), and an incentive redemption module (60). The seller database (20), the user (30) and the incentive management platform (200) are in communication by a wireless network. The purchase module (30) is configured to complete the purchase when accessed by the user for merchandise sold by the seller at the registered seller domain (20). The transaction module (40) is configured to perform the purchase transaction. The incentive generation module (50) is configured to generate an incentive value from the transaction value for a predetermined period of time. The value of the incentive is determined as equal, less or greater than the purchase transaction value made by the user. The platform (200) is configured to perform the incentive management for any value of the purchase transaction. An incentive storage module (70) stores and enhances the incentive value until the completion of the predetermined period. The redemption module (60) redeems the value of the incentive to the user after the completion of the predetermined time period, notifies and distributes it to the user. The incentive management platform (200) is configured to return complete transaction value as an incentive to the user dynamically after the pre-determined period of time.

The incentive management platform (200) is a purchase interface between the merchant or seller and the user. The incentive management system is configured to display the merchandise of the registered seller. The incentive management system is a network enabled system which can be accessed using any computer or a network implementable device. The incentive includes one of cash back, statement credit and amount redeemable on selected goods and services. The incentive management platform (200) generates activity reports on incentive activity for the sellers. The incentive management platform (200) tracks the buying pattern of the user and stores in the database (90). The incentive generation module (50) uses the margins existing in the purchase transactions to be segregated and set aside for the incentive as cash-back to the customer. The registered user domain or database (10) displays the predetermined time after which the user is redeemed with the incentive value on communication by the incentive management platform (200). The incentives are distributed to the platform (200) by the seller and are being viewed and accessed by the network enabled system. The incentives are maintained by the incentive management platform (200) and the predetermined time period for redemption of incentive. The network operated device is a computer, desktop, laptop, or any hand held computer or a mobile phone with data connectivity.

A method of automated incentive management by an incentive management system (100) is provided with the following steps. A seller domain or database (20) is accessed for purchase of any article or entity, by a user and user authentication of the database. A purchase transaction of the article or entity is completed by the user on the seller domain (20) accessed on registered user domain (30) and executed by transaction module (40). The transaction event is network implemented communicated to an incentive management platform (200) in communication with the seller domain (20) and the user domain (30) through a wireless network. The incentive is managed by the incentive management platform (200) for a predetermined period configured to reimburse the user with the predefined purchase transaction value. The platform (100) is configured to invest the aggregated margins through the transaction and provide back to the customer as incentive. The platform (100) is incentive management through an investment of the margin availed in the wealth management plan based on customer interest for a predetermined period of time. The management of the incentive comprises of determination of part of the transaction value to be deducted from the transaction value by the incentive generation module (50) on the incentive management platform (200). The deducted margin value is stored in the incentive storage module (70) for a predetermined period of time. The incentive redemption process is executed to the registered user domain by the incentive redemption module (60) on completion of the predetermined period. The dashboard of the end user is updated with the time period for complete redemption of the transaction value. The incentive is managed by the platform (200) during the predetermined period for maturity of the incentive value deducted by the platform to the total purchase incentive value. The redemption of the incentive to the user on completion of the predetermined maturity period is completed. The incentive redemption module (60) supports the dynamic growth of cash back based on time. The period of maturity is the time period configured by the incentive management platform (200) for the deducted margin value on the transaction to equalize to the total purchase transaction value.

The invention relates to incentive management system, preferably a computer implemented incentive management system that provides the user of the system or platform with complete redemption of the purchase value as incentive, done by means of the platform. This concept redefines target marketing and rebating. In the preferred embodiment, the invention provides a platform means that is implemented by a network operated device for the merchant or seller of various brands and advertisers to display incentive offers and rebates on the platform, which is amenable to access by any network operated device. The network operated device is a computer, desktop, laptop, or any hand held computer or a mobile phone with data connectivity. Distributing offers in this manner allows the sellers to control what is displayed, to whom and for how long. It also reduces the time and wastes incurred in conventional marketing approaches.

The invention incorporates some aspects of existing approaches. End users are provided with 100% cash back to enhance their wealth management as they spend. But the major consideration is providing detection of duplicate redemptions, for package goods and other incentive offers and automatically, electronically redeeming rebates. The present invention provides a platform that converts all spends into earnings with respect to time period.

The incentive management system or platform detailed in the invention provides redemption facilities to the user. This also allows for remuneration for services to be based on redemption only, making this a true wealth management platform that triggers one to spend wise to earn wise. And it provided the capability of accounting and tracking rebates at the point of redemption with respect to a particular time or a predetermined time involved.

This redemption approach makes the automatic rebate approach possible through the incentive management system. Once the 100% cash back are redeemed, the information is relayed to the Inventor, who applies a credit for applicable participants (shoppers) rebate. This electronic rebate is provided to those shoppers/users who the specifically registered to the cash back offers on the platform or system. This cash back strategy is intended to save the shopper/user even more money and time while creating more loyalty between the shopper and the brand.

An embodiment of the invention provides an online approach to distribute promotions, eliminate duplicate rebates and to motivate end users to spend wisely, retailers or others, motivated by profiting on inflated redemptions and to immediately reward consumer loyalty by automatically providing, rebates electronically, following redemption, with no submission required by the consumer.

In another preferred embodiment, the invention provides a platform means for Brands and Advertisers to display incentive offers and rebates in an online platform. Distributing offers in this manner allows them to control what is displayed, to whom and for how long. It also reduces the time and wastes incurred in conventional marketing approach.

The invention incorporates some aspects of existing approaches. End users are provided with 100% cash back to enhance the wealth management in the environment. But the major consideration is providing detection of duplicate redemptions, for package goods and other incentive offers and automatically, electronically redeeming rebates. The inventor has built a formidable platform that shows wealth management in a different perspective. This platform provides a solution to convert all spends into earnings with respect to time period.

The proprietary platform detailed in the invention, provides redemption facilities the availability to process. This also allows for remuneration for services to be based on redemption only, making this a true wealth management platform that triggers you to spend wise to earn wise. And it provided the capability of accounting and tracking rebates at the point of redemption with respect to a particular time involved.

The preferred embodiment of the present invention illustrates an example wherein the incentive management system hosts the seller or merchant's merchandise like a property on sale, the end user or customer is a registered user on the platform. The end user performs the search to buy a property. The process to buying a property involves series of actions such as “search, shortlist, check loan eligibility, book a visit, request document and then the payment is made online”. After the payment is made online the seller changes the status of the property to “sold” and updates the registered end user. Once updated, the end user's account undergoes the incentive redemption process. The dashboard of the end user is updated with the time period after which the end user will receive the 100% cash back for the value spent on the property. In practicality, the proofs and documents uploaded with respect to the property are verified by the admin so as to avoid duplicates or illegal usage of the platform.

The preferred embodiment of the present invention generally illustrates the buying process involved in buying a product. The end user performs searches to find the desired product. The product the end user finds can be added to the cart or can be bought directly. The product payment is performed online. The incentive management system is attributed a fixed margin for every purchase done through it by the seller which gets deducted every time a purchase is made through the platform. The margin is deducted from the seller account with respect to the product/property posted on the platform. The proprietary platform/system, then splits the margin and a part of which is absorbed for the incentive management process. The margin that is absorbed for the incentive management process is notified to the end user on the successful purchase of the product/property. The dash board of the end user is notified with a digital clock that counts down the time period to receive 100% cash back.

The margin that was absorbed for the incentive management process is allowed to grow and mature within the time period calculated. As the amount matures with the time and post this process the end user now is eligible to receive the 100% cash back. The present invention also provides a unique electronic approach to notify the end user to collect the 100% cash spent on the buy on the platform. The present invention also provides a unique electronic approach to automatically process and track rebates. No post purchase activity is required of the shopper.

An electronic, online approach provided to brand manufacturers and advertisers to target market specific incentive offers which is electronically provide rebates as building customer loyalty and building an environment that is strong and is well developed in wealth management. A proprietary cash back platform, connecting all spend of the end user and rebate information; A server maintaining all information, fully accessible to the Store and Isoft admin. The specific departments are issued to contracting brands and advertisers (Stores). These departments are actually display areas controlled by the Stores, hosted on the platform. Each Store's department is proprietary. A variety of Stores may participate on the platform, and can provide an infinite number of items or categories. Access into each department is gained through confidential passwords and login codes established and maintained by the Stores and the platform.

The Stores produce and submit their own offers to be displayed in their departments, showcased on the Inventor's Internet website. The Stores has the ability to maintain their own departments and their own displays. The Stores determine how many offers are to made available daily. The Stores determine what regions are to receive what incentives. Incentive offers may be national, regional or local, in scope. Each offer displayed by a Store may contain indigenous information such as the Store name, the item or brand name, the value of the incentive, disclaimers and modifiers for the incentive, the origin of the incentive by zip code and the 100% cash back mark. The 100% cash back displayed in the website are viewed and availed by end users/web shoppers over a period of time.

The cash back is free to the end user and are available twenty-four hours a day, seven days a week, is viewable and can be availed by the end user, at their discretion and are availed offline by the end users. Every rebate is identified and maintained in the proprietary back end database, by the platform. The 100% cash back may contain items referenced in the following: Demographic information provided by the end user (web shopper) i.e. name, date of birth, sex, marital status, and other personal information. Time and date of purchase, product name, and price associated with cash back. All the information is tracked and is stored in the back end.

The cash back database maintains all necessary information regarding the Stores, their departments, displays, links, rebates and customer accounts. The Activity Reports on incentive activity are available to the Stores though the platform proprietary, backend database. The Activity reports provide the brands and advertisers tracking capability:

Where each item is displayed in their Store: How many web shoppers saw the display (impressions), how many web shoppers actually viewed the incentive offer, how many web shoppers actually showed interest in the cash back property, where the web shoppers are based. Where the incentives were provided and redeemed. From what regions web shoppers came. What was the heaviest concentration of activity and when. How large their loyalty base on their brand. The above mentioned reports may be viewed online or printed out by the Store.

The identification and enhance the spend pattern, as well as the automatic 100% cash back are accomplished by: Tracking of impressions and activities for the incentives displayed by the Stores, and submitted to redemption facilities, Proprietary platform is utilized at the redemption level to track activity on packaged goods as well as to determine rebate eligibility, Information is retrieved at the time of the purchase and accumulated as the incentives are processed by redemption facilities.

The 100% cash back are automatically provided to shoppers by the brands, following the redemption process. The shopper receives the notification for the rebate and the time associated with that, once the time period is accomplished redeeming all spend as earn takes place. There is no post purchase submission required by the consumer to get their rebate. It occurs automatically through the cash back system. The data extracted can be used to determine incentive count, as well as to suggest and enhance the customer buy experience. 100% cash back are not to be copied or altered in any way. If fraudulent activities occur they can be identified and traced back to their point of origin, by their identification numbers and other pertinent data such as address, IP address or zip code. The platform accumulates redemption information for the accounting and distribution of the electronic rebates provided by the brand (Stores) as they are earned by the Web Shopper.

Although, the invention has been described and illustrated with respect to the exemplary embodiments thereof, it should be understood by those skilled in the art that the foregoing and various other changes, omissions and additions may be made therein and thereto, without parting from the spirit and scope of the present invention.

We claim:

1. An incentive management system (100) comprising:
a registered seller domain/database (20);
a registered user domain/database (10);
a purchase module (30);
a transaction module (40);
a database/memory (90) for data storage; and
an incentive management platform (200), comprising of an incentive generation module (50), an incentive storage module (70), and an incentive redemption module (60),
wherein the seller database (20), the user (30) and the incentive management platform (200) are in communication by a wireless network,
wherein the purchase module (30) is configured to complete the purchase when accessed by the user for merchandise sold by the seller at the registered seller domain (20),
wherein the transaction module (40) is configured to perform the purchase transaction,
wherein the incentive generation module (50) is configured to generate an incentive value from the transaction value for a predetermined period of time,
wherein the value of the incentive is determined as equal, less or greater than the purchase transaction value made by the user,
wherein the platform (200) is configured to perform the incentive management for any value of the purchase transaction,
an incentive storage module (70) that stores and enhances the incentive value until the completion of the predetermined period,
wherein the redemption module (60) redeems the value of the incentive to the user after the completion of the predetermined time period, notifies and distributes it to the user, and
wherein the incentive management platform (200) is configured to return complete transaction value as an incentive to the user dynamically after the pre-determined period of time.

2. The incentive management system (100) as claimed in claim 1, wherein the incentive management platform (200) is a purchase interface between the merchant or seller and the user.

3. The incentive management system (100) as claimed in claim 1, wherein the incentive management system is configured to display the merchandise of the registered seller.

4. The incentive management system (100) as claimed in claim 1, wherein the incentive management system is a network enabled system which can be accessed using any computer or a network implementable device.

5. The incentive management system (100) as claimed in claim 1, wherein the incentive includes one of cash back, statement credit and amount redeemable on selected goods and services.

6. The incentive management system (100) as claimed in claim 1, wherein the incentive management platform (200) generates activity reports on incentive activity for the sellers.

7. The incentive management system (100) as claimed in claim 1, wherein the incentive management platform (200) tracks the buying pattern of the user and stores in the database (90).

8. The incentive management system (100) as claimed in claim 1, wherein the incentive generation module (50) uses the margins existing in the purchase transactions to be segregated and set aside for the incentive as cash-back to the customer.

9. The incentive management system (100) as claimed in claim 1, wherein the registered user domain or database (10) displays the predetermined time after which the user is redeemed with the incentive value on communication by the incentive management platform (200).

10. The incentive management system (100) as claimed in claim 1, wherein the incentives are distributed to the platform (200) by the seller and are be viewed and accessed by the network enabled system.

11. The incentive management system (100) as claimed in claim 10, wherein the incentives are maintained by the incentive management platform (200) and the predetermined time period for redemption of incentive.

12. The incentive management system (100) as claimed in claim 1, wherein the network operated device is a computer, desktop, laptop, or any hand held computer or a mobile phone with data connectivity.

13. A method of automated incentive management by an incentive management system (100), comprising of steps:
accession of a seller domain or database (20) for purchase of any article or entity, by a user and user authentication of the database;
completion of a purchase transaction of the article or entity by the user on the seller domain (20) accessed on registered user domain (30) and executed by transaction module (40);
network implemented communication of the transaction event to an incentive management platform (200) in communication with the seller domain (20) and the user domain (30) through a wireless network;
management of the incentive by the incentive management platform (200) for a predetermined period configured to reimburse the user with the predefined purchase transaction value;
wherein the platform (100) is configured to invest the aggregated margins through the transaction and provide back to the customer as incentive,
wherein the platform (100) is incentive management through an investment of the margin availed in the wealth management plan based on customer interest for a predetermined period of time,
wherein the management of the incentive comprises of determination of part of the transaction value to be deducted from the transaction value by the incentive generation module (50) on the incentive management platform (200),
storing the deducted margin value in the incentive storage module (70) for a predetermined period of time,
execution of the incentive redemption process to the registered user domain by the incentive redemption module (60) on completion of the predetermined period,
updating dashboard of the end user with the time period for complete redemption of the transaction value,
management of the incentive by the platform (200) during the predetermined period for maturity of the incentive value deducted by the platform to the total purchase incentive value,
redemption of the incentive to the user on completion of the predetermined maturity period, and
wherein the incentive redemption module (60) supports the dynamic growth of cash back based on time.

14. The method of automated incentive management by an incentive management system (100) as claimed in claim 13, wherein the period of maturity is the time period configured by the incentive management platform (200) for the deducted margin value on the transaction to equalize to the total purchase transaction value.
